(19) United States
(12) Patent Application Publication
(10) Pub. No.: US 2012/0268792 A1
(43) Pub. Date: Oct. 25, 2012

(54) PRINT PROCESSING APPARATUS, PRINT PROCESSING METHOD, AND PRINT CONTROL PROGRAM

(75) Inventor: Hiroshi Ozaki, Kawasaki-shi (JP)

(73) Assignee: CANON KABUSHIKI KAISHA, Tokyo (JP)

(21) Appl. No.: 13/442,304

(22) Filed: Apr. 9, 2012

(30) Foreign Application Priority Data
Apr. 21, 2011 (JP) 2011-095128
Feb. 21, 2012 (JP) 2012-034976

(51) Int. Cl. G06K 15/02

(52) U.S. Cl. 358/1.18

(57) ABSTRACT

The print processing apparatus can set to perform either the page layout process for each page of the book-bound sheet bundle or the page layout process for the spread pages for the book-bound sheet bundle during bookbinding printing. At the time of combining the page layout function with the bookbinding print function, the arrangement of a plurality of pages on the spread pages for the book-bound sheet bundle is controlled if the page layout process for the spread pages for the book-bound sheet bundle during bookbinding printing is set. When a page-order mismatch occurs in the arrangement order specified for page layout, the arrangement order of pages which are a front cover and a rear cover of the book-bound sheet bundle is changed so as to maintain the integrity of the page order.

### BACKGROUND OF THE INVENTION

1. Field of the Invention

The present invention relates to a printing technology for performing a bookbinding print process and a page layout process for providing a book-bound sheet bundle. In particular, the present invention relates to print setting control of a printer driver which enables printing by a printing device.

2. Description of the Related Art

There is software called a “printer driver” that instructs a printing device such as a printer or the like to perform printout from application running on an operating system (hereinafter referred to as “OS”) mounted on an information processing apparatus. The printer driver can designate various print settings such as the selection of the sheet feeding cassette, setting of the color processing method, the selection of the sheet discharge method and the like. Also, a print function for saving sheets of paper by allocating data for a plurality of logical pages into a single physical sheet (also referred to as “output sheet”) for printout is known. A logical page is a page as a processing unit to be treated within an information processing apparatus by means of application or the like, and is distinguished from a physical page to be added to an output sheet for actual printout.

A printer driver has a page layout function that arranges print data for a plurality of logical pages on one surface of a physical sheet, i.e., a physical page. The page layout function can also specify how many pages are to be arranged on an output sheet as well as their arrangement order. Also, the bookbinding print function is a function that arranges different print data on half of the area of each physical page and folds the output sheets along the boundary in a bundled state to thereby obtain a book-bound sheet bundle as a finishing article. Japanese Patent Laid-Open No. 2002-200814 discloses a technique that can Arrange data for a plurality of pages on each page and one print data can be printed on a spread page when a printed matter is bounded to be a book-bound sheet bundle.

In the prior art, when the page layout, function and the bookbinding print function are used in combination, the page layout process is performed for each logical page of the book-bound sheet bundle, and thus, the page layout process cannot be performed for each spread over two logical pages during bookbinding. In other words, a user cannot select either the page layout, process for each spread over two logical pages for the book-bound sheet bundle or the page layout process for each page.

### SUMMARY OF THE INVENTION

The present invention realizes a print process for creating the page layout of the book-bound sheet bundle in the spread-out manner when the bookbinding print function and the page layout function are used in combination in the book-bound sheet bundle.

According to an aspect of the present invention, a print processing apparatus is provided that includes a setting unit configured to set a first layout process for arranging a page of original data on each of a first printing area and a second printing area both constituting spread pages of a book or set a second layout process for arranging a page of original data across the spread pages of the book; and a print control unit configured to generate print data in which a plurality of pages is continuously arranged on the first printing area constituting the spread pages of the book and a plurality of pages subsequent to the plurality of pages arranged on the first printing area is continuously arranged on the second printing area when the first layout process is set by the setting unit or generate print data in which a plurality of pages is continuously arranged across the first printing area and the second printing area when the second layout process is set by the setting unit, wherein a printed matter obtained when the first layout process is set and a printed matter obtained when the second layout process is set have a different layout of the original data in the spread pages of the book.

According to the present invention, the page layout of the book-bound sheet bundle can be created in the spread-out manner when the bookbinding print function and the page layout function are used in combination in the book-bound sheet bundle.

Further features of the present invention will become apparent from the following description of exemplary embodiments with reference to the attached drawings.

### BRIEF DESCRIPTION OF THE DRAWINGS

FIG. 1 is a block diagram illustrating an example of a system configuration using a print processing apparatus according to an embodiment of the present invention.

FIG. 2 is a block diagram illustrating an example of software configuration for explaining a typical print data generation method performed by a host computer.

FIG. 3A is a diagram illustrating an example of a display screen for explaining the page layout function of a printer driver.

FIG. 3B is a diagram illustrating an example of page layout selection for explaining the page layout function of a printer driver.

FIG. 3C is a diagram illustrating an example of arrangement order selection for explaining the page layout function of a printer driver.

FIG. 4A is a diagram illustrating an example of a display screen for explaining the bookbinding print function of a printer driver.

FIG. 4B is a diagram illustrating an example of a display screen for explaining the detailed setting of the bookbinding print function of a printer driver.

FIGS. 5A to 5E are explanatory diagrams illustrating an example of the processing of the bookbinding print function of a printer driver.

FIGS. 6A to 6E are explanatory diagrams illustrating an example of the combined process of the bookbinding print function and the page layout function.

FIGS. 7A to 7E are explanatory diagrams illustrating an example of the combined process of the bookbinding print function and the page layout function in a spread layout.

FIGS. 8A to 8E are diagrams illustrating a mismatch in the page order, which occurs when the arrangement order of the page layout is combined with bookbinding printing.

FIGS. 9A to 9E are explanatory diagrams illustrating an example of processing for automatically changing the page layout of a front cover and a rear cover depending on the spread-out direction of the book-bound sheet bundle.

FIGS. 10A and 10B are explanatory diagrams illustrating an example of processing for inserting data for blank pages into original data and arranging the resulting data on the physical sheet of the book-bound sheer bundle.

FIGS. 11A to 11E are explanatory diagrams illustrating an example of the spread layout during bookbinding printing under the setting of one page/sheet.

FIGS. 12A and 12B are flowcharts illustrating an example of control according to the present embodiment.

FIG. 13 is a flowchart illustrating an example of how control is performed when the bookbinding print function is set under the setting of one page/sheet.

FIG. 14 is a diagram illustrating an example of a printed matter.

### DESCRIPTION OF THE EMBODIMENTS

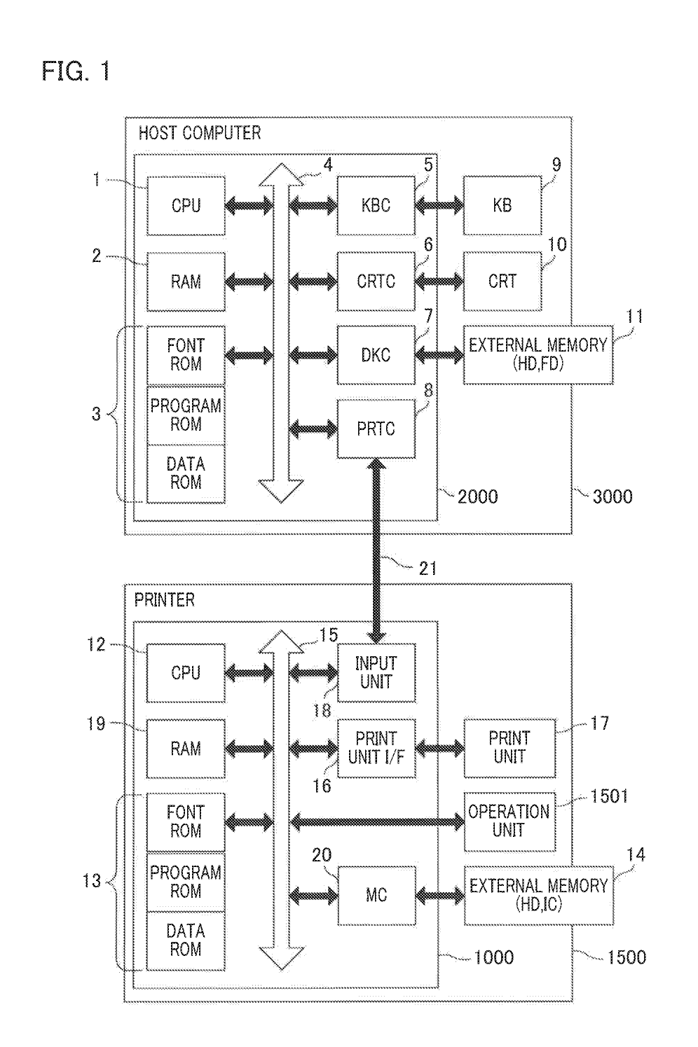

Hereinafter, preferred embodiments of the present invention will be described with reference to the attached drawings. FIG. 1 is a block diagram illustrating an example of a configuration of a printer control system using a print processing apparatus according to the present embodiment. In the present embodiment, the print processing apparatus can execute the function of the page layout process for arranging print data for a plurality of pages on printing areas of output sheets in the specified arrangement order. In addition, the print processing apparatus can execute the function of a bookbinding print process for arranging print data on areas split each half of the printing area of the output sheet and folding the output sheets in a bundled state to thereby obtain a book-bound sheet bundle. Note that an environment in which these functions are executed may be a single apparatus or a system consisting of a plurality of apparatuses. The present invention is also applicable to a system that performs processing by establishing connections via a computer network such as LAN (Local Area Network), WAN (Wide Area Network), or the like.

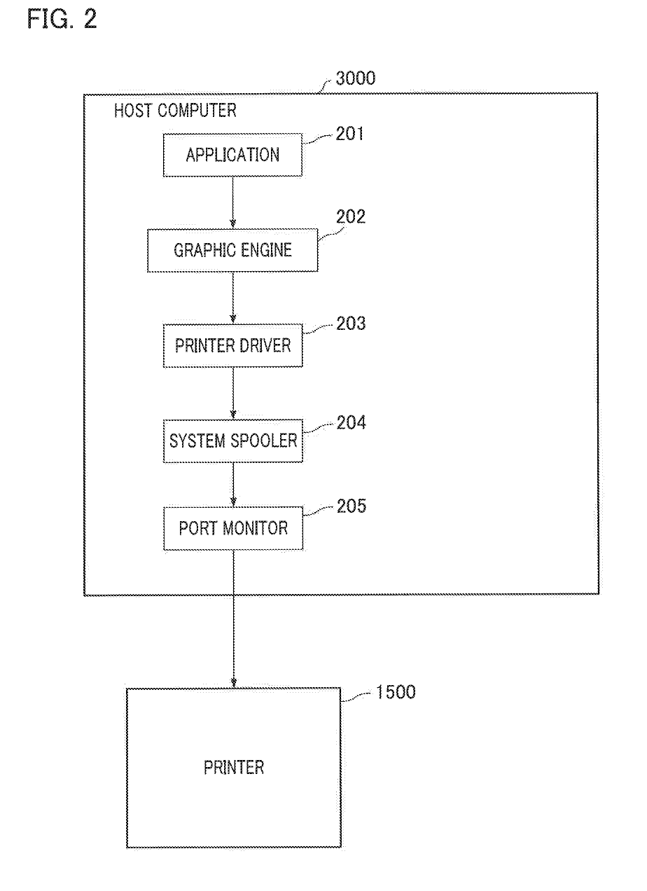

A host computer 3000 shown in FIG. 1 includes a CPU (Central Processing Unit) 1 and executes processing for document data in which graphics, images, characters, tables (including spreadsheets or the like), and the like coexist on the basis of a document processing program or the like. The document processing program is stored in a program ROM in a ROM (Read Only Memory) 1 or an external memory 11. The CPU 1 generally controls devices which are connected to a system bus 4. Also, the program ROM in the ROM 3 or the external memory 11 stores an OS program or like which is the control program executed by the CPU 1. The font ROM in the ROM 3 or the external memory 11 stores font data or the like used in document processing. The data ROM in the ROM 3 or the external memory 11 stores various data used in document processing or the like. A RAM (Random Access Memory) 2 functions as a main memory, a work area, or the like of the CPU 1. A keyboard controller (KBC) 5 controls key input from a keyboard 9 or a pointing device (not shown). A CRT controller (CRTC) 6 controls display on a display (CRT) 10. A disk controller (DKC) 7 controls access to the external memory 11 such as a hard disk (HD) a flexible disk (FD), or the like. These storage devices stores a boot program, various applications, font data, a user file, an editing file, a print control program, and the like. Hereinafter, a printer control command generation program used for print control is referred to as “printer driver” see FIG. 2).

A printer controller (PRTC) 8 is connected to a printer 1500 via a predetermined bi-directional I/F (interface) 21, and executes a communication control process for print data or the like with the printer 1500. The CPU 1 executes a developing (rasterizing) process of an outline font into a display information RAM set on the RAM 302, thereby enabling WYSIWYG to be realized on the display 10. The CPU 1 opens various registered windows and executes various data processes on the basis of commands instructed by a mouse cursor or the like (not shown) displayed on the screen of the display 10. When a user instructs an apparatus to execute a print process, he opens a window regarding the print setting and can set a desired printer and set a print processing method for the printer driver including the selection of a print function.

Next, a description will be given of the configuration of the printer 1500. The CPU 12 of the printer 1500 outputs an image signal as output information to a print unit (printer engine) 17, which is connected to a system bus 15, via a print unit I/F 16 on the basis of a control program or the like. A control program is stored in the program ROM in the ROM 13 or is stored in an external memory 11. Font data and the like which are used when output information is generated are stored in the font ROM in the ROM 13. In case of a printer without the external memory 14 such as a hard disk or the like, information which is used on the host computer 3000 and the like are stored in the data ROM in the ROM 13. The CPU 12 performs a communication process with the host computer 3000 via an input unit 18 and notifies the host computer 3000 of the information in the printer 1500 or the like. The RAM 19 functions as a main memory, a work area, or the like of the CPU 12. A memory capacity of the RAM 19 can be expanded by an option RAM connected to an expansion port (not shown). The RAM 19 is used as an output information developing area, an environment data storing area, an NVRAM (Non Volatile RAM), or the like. An access to the external memory 14 such as http:///hard disk (HD), IC card, or the like is controlled by a memory controller (MC) 20. The external memory 14 is connected as an option device and stores font data, an emulation program, form data, and the like. Switches for a user operation, an LED (Light Emitting Diode) display, and the like are arranged on an operation unit 1501. The number of the external memories 14 may be two or more. For example, the external memory 14 can be constructed in a manner such that option font cards in addition to built-in fonts and a plurality of external memories in which a program to interpret printer control languages of different language systems has been stored can be connected to the printer 1500. Furthermore, it is also possible to have an NVRAM (not shown) and store printer mode setting information from the operation unit 1501.

FIG. 2 is a configuration diagram illustrating the flow of a typical printing process performed by a host computer. The host computer 3000 is directly connected to a printing device such as a printer or the like or is connected to a printing device via the network. An application 201, a graphic engine 202, a printer driver 203, a system spooler 204, and a port monitor 205 exist as computer-readable program files held in the external memory 11. Each of which is a program module which is loaded into the RAM 2 by the OS or its module and is executed by the CPU 1. The printer driver 203, the system spooler 204, and the port monitor 205 are used for print control. The application 201 and printer driver 203 can be added to the FD or a CD-ROM (not shown) of the external memory 11 or an HD of the external memory 11 via the network. The application 201 held in the external memory 11 is loaded into the RAM 2 and is executed by the CPU 1. When a user instructs printing from the application 201 to the printer 1500, an output (drawing) process is performed by using the graphic engine 202 which is similarly loaded into the RAM 2 and is in the operative mode. The graphic engine 202 loads the printer driver 203 prepared for every printing device into the RAM 2 from the external memory 11. An output of the application 201 is converted into a printer control command using the printer driver 203. The printer control command is output to the printer 1500 via an interface 21 through the system spooler 204 and the port monitor 205 both loaded in the RAM 2 by the OS.

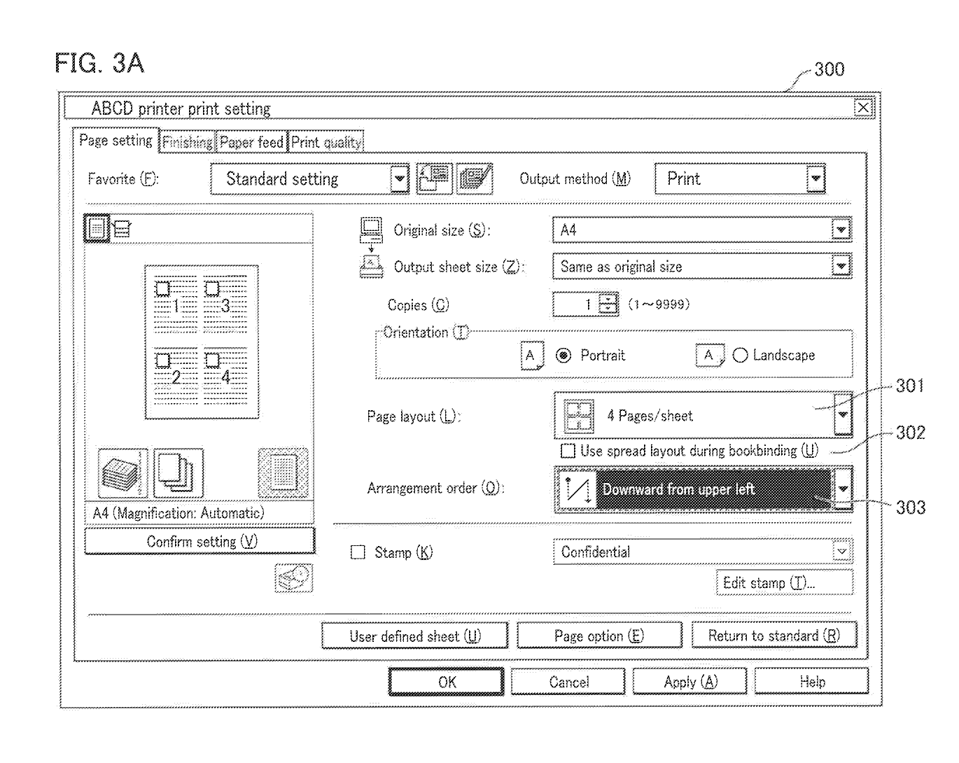

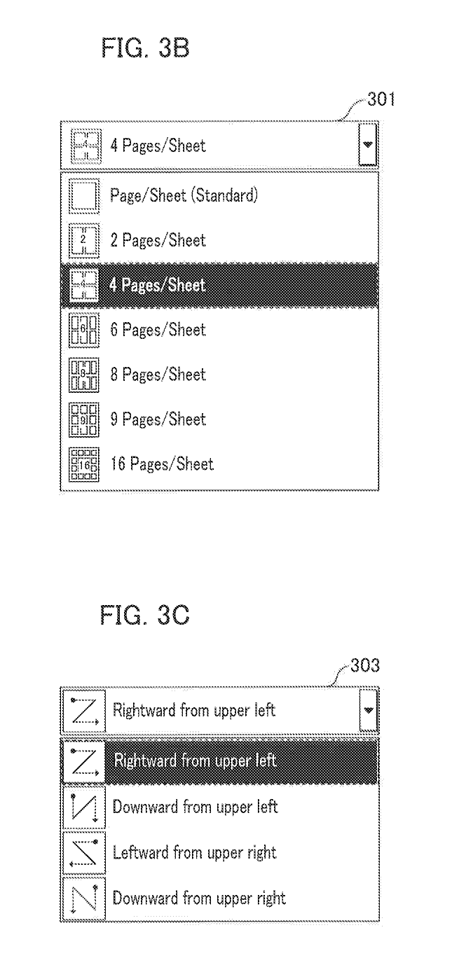

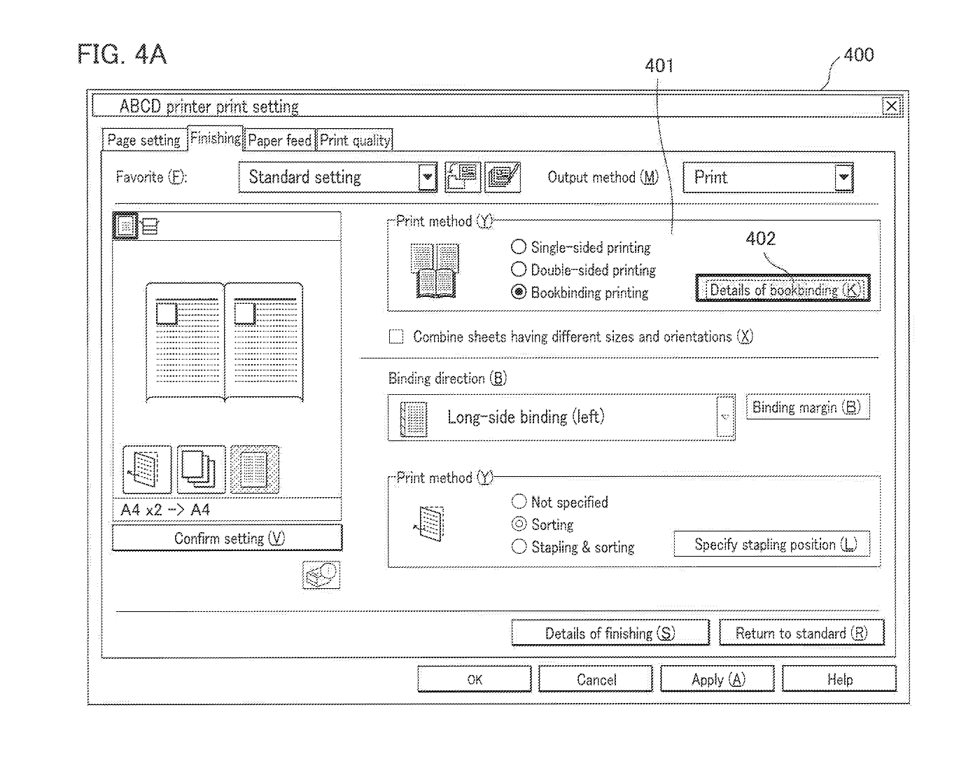

FIG. 3A is a diagram illustrating an example of a user interface (UI) screen for explaining the page layout function of the printer driver 203. The screen is displayed on the screen of the display 10 in accordance with a program interpreted and executed by the CPU 1. The page layout function is a function that arranges print data for the specified plurality of pages on one physical page of an output sheet (one surface of an output sheet). In the page layout function, the number of pages to be arranged on one page and the arrangement order thereof can be specified. An UI screen 300 (page setting screen) shown in FIG. 3A has a page layout setting area 301, a spread layout setting area 302, and an arrangement order setting area 303. A user can set the page layout, using the page layout setting area 301. The contents of the page layout selection are shown in FIG. 3B. The standard setting is “one page/sheet”. When another setting is selected by a user operation, the arrangement order can be set in the setting area 303. The contents of arrangement order selection are shown in FIG. 3C. In the present embodiment, when the setting “four pages/sheet” is selected in FIG. 3B, the arrangement orders which are settable depending on the selected result are “rightward from upper left”, “downward from upper left”, “leftward from upper right”, and “downward from upper right”.

The setting area 302 is an area used when a user specifies the setting “use spread layout during bookbinding”. In the present embodiment, the check box is checked. When the bookbinding print function and the page layout function to be described below are selected and the setting “use spread layout during bookbinding” is not selected, a process for arranging original pages on each page during bookbinding is executed in accordance with the setting contents of the setting areas 301 and 303. Also, when the setting “use spread layout during bookbinding” is selected, a process for arranging a plurality of pages across two pages of the spread pages for the book-bound sheet bundle is executed in accordance with the setting contents of the setting areas 301 and 303.

When the bookbinding print function is selected and the standard setting “one page/sheet” is selected in the setting area 301, a user can select the setting “use spread layout during bookbinding”. In this case, data for a single original page is enlarged and arranged across two pages of the spread pages for the book-bound sheet; bundle.

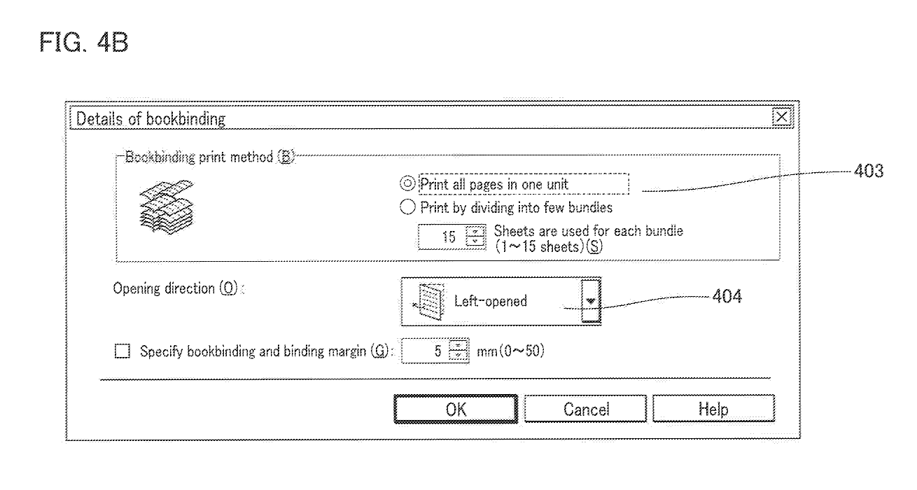

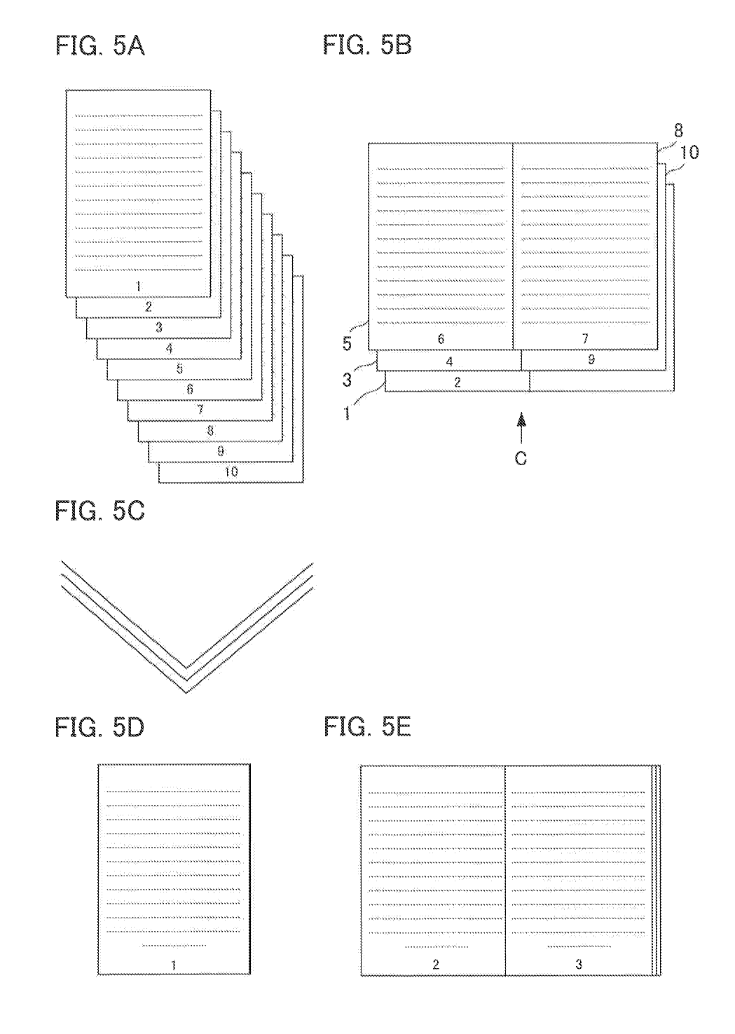

FIGS. 4A and 4B are diagrams illustrating an exemplary UI screen for explaining the bookbinding print function. The bookbinding print function is a print function that arranges print data for two pages on both sides of a physical sheet and folds the boundary between pages to thereby finish it in a book-bound article. In a finishing setting UI screen 400 shown in FIG. 4A, bookbinding printing can be performed by selecting the setting “bookbinding printing” in a printing method setting area 401 through a user operation. In the example shown in FIG. 4A, three options: “single-sided printing”, “double-sided printing”, and “bookbinding printing” are shown. When a user selects “bookbinding printing”, the user can selects a detailed setting button 402. An exemplary UI screen for details of bookbinding, which is displayed when the button is operated by a user, is shown in FIG. 4B. In a setting area 403 for setting a bookbinding printing method, either the setting for finishing the entire pages into one book-bound article or the setting for finishing the entire pages into a plurality of separated books can be made. In a setting area 404, the opening direction of a book-bound sheet bundle can be set. In the present embodiment, the order in which pages are arranged in the left-and-right and up-and-down directions is specified in accordance with the setting. A user can select either left-opened or right-opened or can select either upper-opened or lower-opened depending on the relationship between the orientation of print data and the binding position of the book-bound sheet bundle. Setting information, which has been selected and set by a user operation on UI screens, is reflected to the print control performed by the printer driver 203.

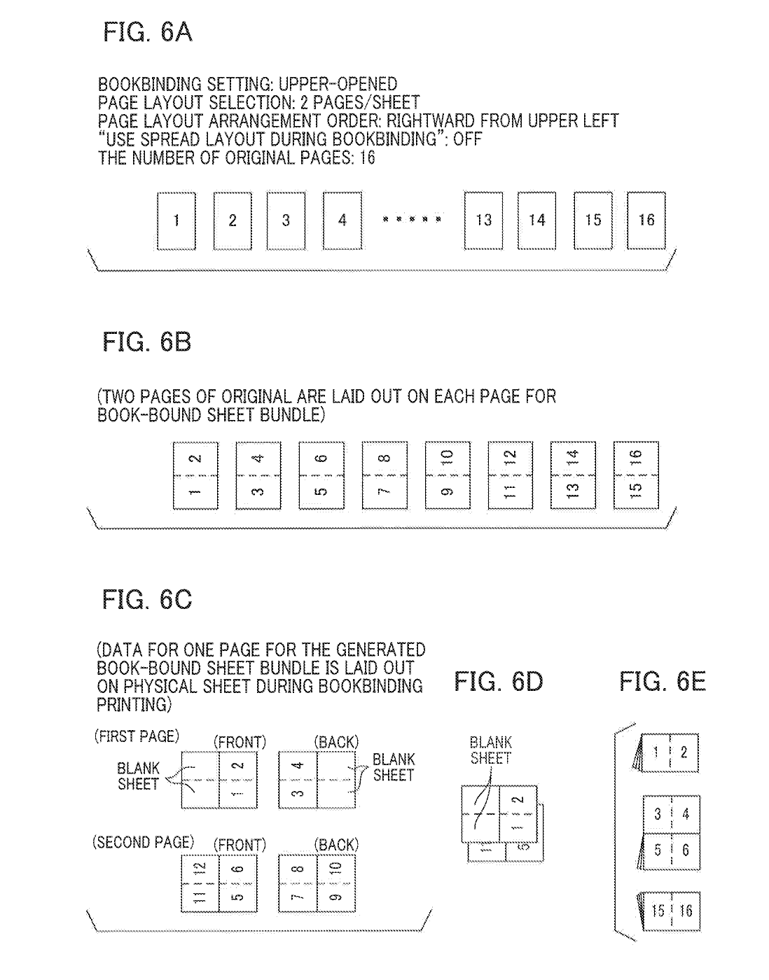

Next, a detailed description will be given of the bookbinding print function with reference to FIGS. 5A to 5E. FIG. 5A shows original data (pages 1 to 10) received by the printer driver 203 when the setting “bookbinding printing” is made on the print setting screen shown in FIG. 4A. FIG. 5B shows the processing result of allocating two pages of original data shown in FIG. 5A into the both sides of each of the physical sheets used during bookbinding printing. In the present embodiment, five pages (second, fourth, sixth, seventh, and ninth pages), which are viewed from the front side (inside) of the physical sheets during bookbinding, are shown and five pages (first, third, fifth, eighth, and tenth pages) are arranged on the rear side (outside) thereof. FIG. 5C is a perspective view illustrating three folded physical sheets as viewed from a side thereof. Assume that pages are assigned in accordance with the page order of the opening direction (in the present embodiment, left-opened) specified in the setting area 404 when sheets are folded along a center line. Upon completion of bookbinding printing, the first page is a front cover as shown in FIG. 5D. When the setting “left-opened” is selected, second page and subsequent pages are laid out as shown in FIG. 5E when a user opens the front cover in the left direction.

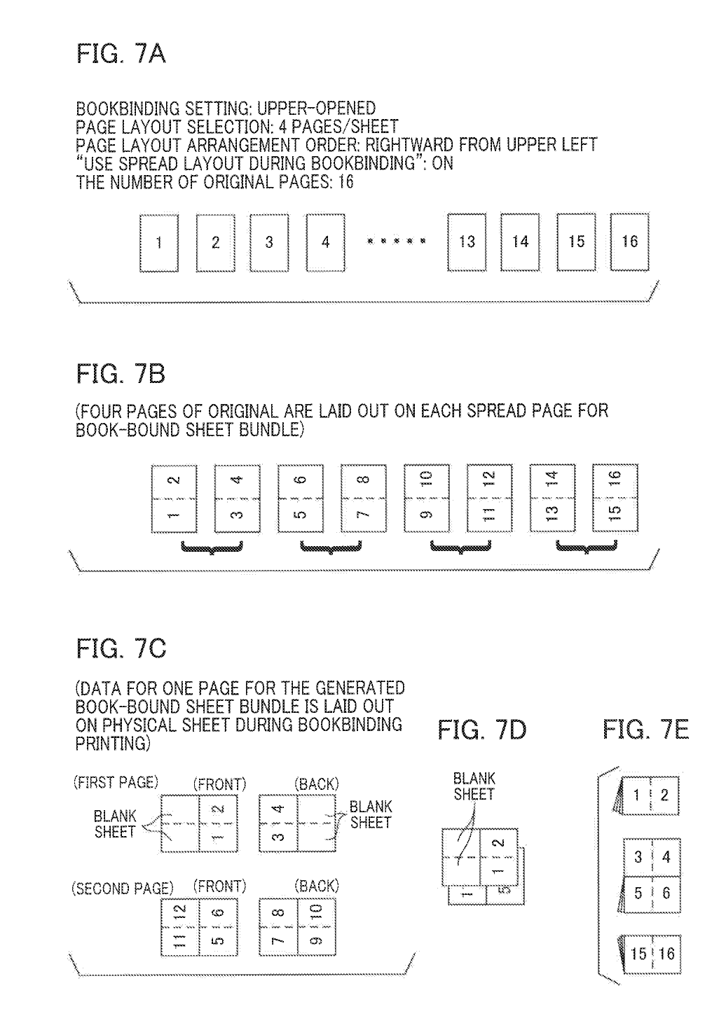

FIGS. 6A to 6E are explanatory diagrams illustrating an example of the combined process of the page layout function and the bookbinding print function. In the present embodiment, assume that the setting “upper-opened” is made as the opening direction, the page layout setting “two pages/sheet” (see FIG. 3B) is specified, and the arrangement order “rightward from upper left” (see FIG. 3C) is specified. Also, assume that the setting “use spread layout during bookbinding” shown in FIG. 3A is not specified.

FIG. 6A shows the original pages (16 pages in total), where the reference numerals 1 to 16 represent page numbers. Firstly, when original data is received, a count process for counting the number of pages is executed, and each original page is arranged in accordance with the specified page layout setting and the specified arrangement order. FIG. 6B shows the state in which two of the original pages are laid out on each page of the spread pages for the book-bound sheet bundle. Mote that two pages constituting the spread pages may also be called as a “first printing area” and a “second printing area”. In the present embodiment, when a whole number variable “P” is in the range of from 1 to 8, the variables (2×P−1, 2×P) are shown as one set. A process for arranging the original pages in accordance with the opening direction is executed so as to obtain the book-bound sheet bundle. FIGS. 6C to 6E show an exemplary layout of data for each page of the original pages, which are assigned to the physical sheets during bookbinding printing. FIG. 6C shows the front and back sides of each of the first and second physical sheets. The blank sheet represents an area to which no page is assigned, the front side of the first physical page indicates two pages of (1, 2) and two “blank sheets”, and the back side thereof indicates two pages of (3, 4) and two “blank sheets”. When a book-bound sheet bundle is completed by overlaying physical sheets as shown in FIG. 6D, an upper-opened printed matter is obtained as shown in FIG. 6E. Thus, bookbinding printing can be performed in accordance with the specified page layout setting.

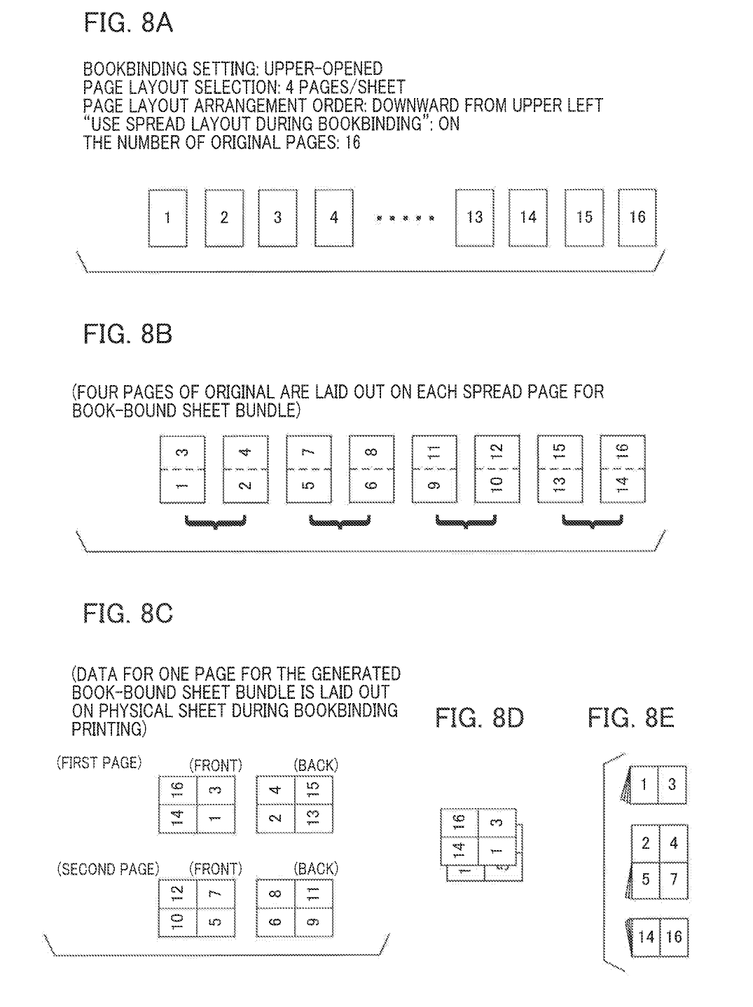

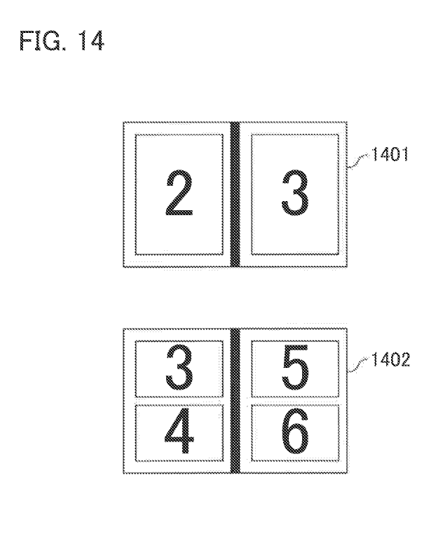

FIGs. 7A to 7E are explanatory diagrams when the setting “use spread layout during bookbinding” shown in FIG. 3A is made. The difference from the setting condition shown in FIGS. 6A to 6E is that the page layout setting “four pages/sheet” is selected. In this case, four pages are arranged on the spread pages for the book-bound sheet bundle is performed. Thus, as shown in FIG. 7B, the original pages from page 1 to page 16 shown in FIG. 7A are arranged in two-page increments on each page of the spread pages for the book-bound sheet bundle. In other words, in the present embodiment, when a whole number variable “P” is in the range of from 1 to 4, a pair of (4×P−3, 4×P−2) and (4×P−1, 4*P) is arranged on each page of the spread pages of a hook. FIGS. 7C to 7E show an exemplary layout of data for each page of the document pages, which are assigned to the physical sheets during bookbinding printing. The results are the same as those shown in FIGS. 6C to 6E, i.e., those obtained when the layout, setting “two pages/sheet” is applied to each logical page of the book-bound sheet bundle when the setting “use spread layout during bookbinding” is not made. Those results are obtained when the page number of print data laid out between the logical pages for the book-bound sheet bundle is not reversed. When only the setting “use spread layout during bookbinding” among the settings used in the description of FIGS. 7A to 7E is changed OFF (first layout process), logical pages are arranged in four-page increments on each page of the spread pages of a book. Consequently, eight logical pages are arranged across two pages of the spread pages of the book. Thus, even when the same number of layout pages is set, a printed matter obtained when the setting “use spread layout during bookbinding” is set ON has a different layout from a printed matter obtained when the setting “use spread layout during bookbinding” is set OFF. For example, FIG. 14 shows printed matters 1401 and 1402 obtained when the setting “left-opened” is made as the opening direction and the setting “use spread layout during bookbinding” is different. The printed matter 1401 shown in FIG. 14 is an exemplary printed matter obtained when the layout setting “two pages/sheet” is made and the setting “use spread layout during bookbinding” is ON. On the other hand, the printed matter 1402 shown in FIG. 14 is an exemplary printed matter obtained when the layout setting “two pages/sheet” is made and the setting “use spread layout during bookbinding” is OFF.

As described above, a printed matter obtained when the first layout process in which the setting “use spread layout during bookbinding” is OFF is set and a printed matter obtained when the second layout process in which the setting “use spread layout during bookbinding” is ON is set have a different layout of the original data in the spread pages of the book.

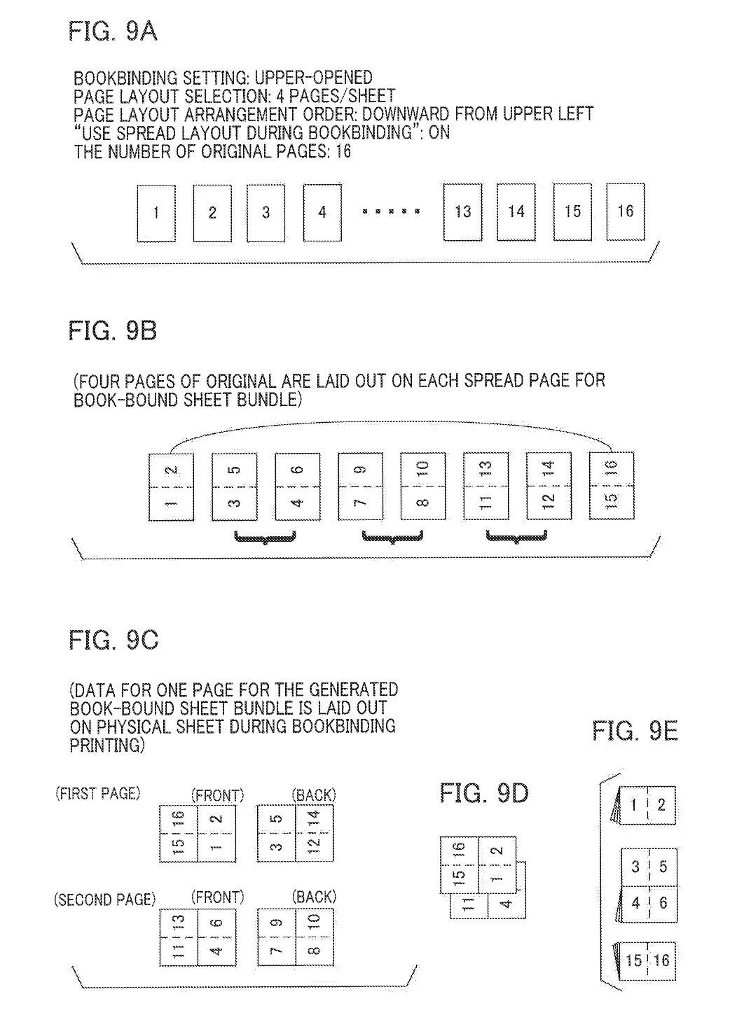

FIGs. 8A to 8E are explanatory diagrams when the arrangement order “downward from upper left” shown in FIG. 3C is specified. Other setting conditions are the same as those in FIGS. 7A to 7E. Thus, as shown in FIG. 5B the original pages from page 1 to page 16 shown in FIG. 8A are arranged in two-page increments on each page of the spread pages for the book-bound sheet bundle. In other words, in the present embodiment, when a whole number variable “P” is in the range of from 1 to 4, a pair of (4×P−3, 4×P−2) and (4×P−1, 4×P) is subjected to layout arrangement. FIGS. 8C to 8E show an exemplary layout of data for pages for the generated book-bound sheet bundle, which is assigned to the physical sheets during bookbinding printing. Four pages (1, 3) and (14, 16) are assigned to the front side of the first sheet shown in FIG. 8C. It should be noted that there is no integrity between adjacent portions such as the front cover of (1, 3) or the text of (2, 4), (5, 7), and the like. As described above, when original data is arranged over the fold position, along which a book-bound sheet bundle is folded, as the arrangement order of “downward from upper left” or “downward from upper right”, a mismatch in the page order of both the front cover/text occurs.

In order to solve the mismatch, it is necessary to maintain the page order for the front cover and the rear cover which are not spread pages for a book-bound sheet bundle by prohibiting the arrangement order that arranges original data over the fold position.

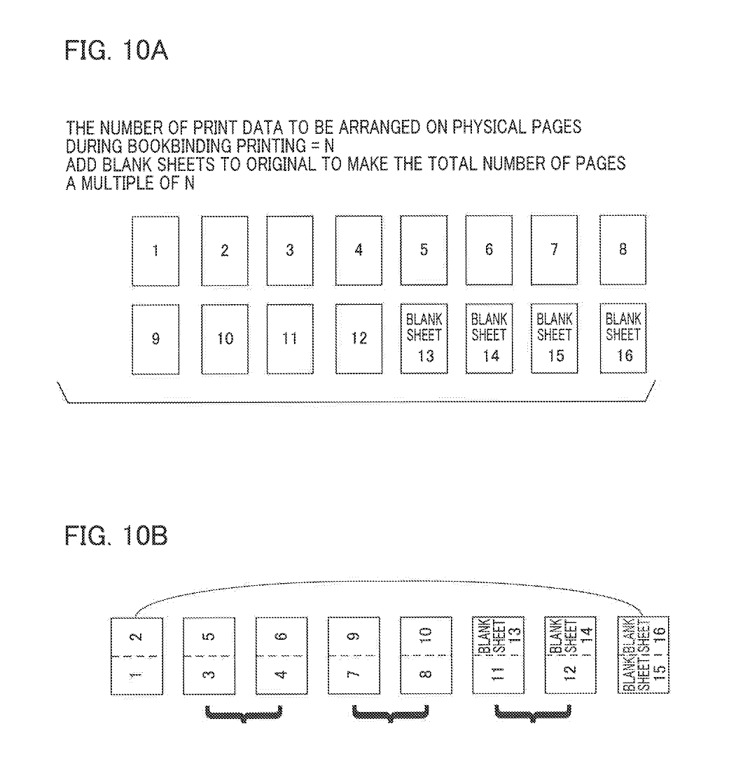

FIGS. 9A to 9E are explanatory diagrams illustrating an example of processing for automatically changing the arrangement order so as not to occur a mismatch in the page order during bookbinding printing. The setting condition is the same as that shown in FIGS. 8A to 8E, the specified arrangement order (downward from upper left) is applied to third to fourteenth pages during bookbinding printing. A layout process for assigning each four pages of the original pages from page 1 to page 16 shown in FIG. 9A to each two pages for the book-bound sheet bundle as shown in FIG. 9B is performed. In other words, the pages of (1, 2) is assigned to the front cover and the pages of (15, 16) is assigned to the rear cover. For text pages other than pages of the front cover and the rear cover, when a whole number variable “P” is in the range of from 1 to 3, the pages of a pair of (4×P−1, 4×P+1) and (4×P, 4×P+2) appear on a spread page. FIGS. 9C to 9E show an exemplary layout of data for each page of the document pages, which are assigned to the physical sheets during bookbinding printing. Four pages (1, 2) and (15, 16) are assigned to the front side of the first sheet shown in FIG. 9C and four pages (3, 5) and (12, 14) are assigned to the back side thereof. The integrity between the adjacent portions in two pages of the spread pages of text in a book is maintained. In other words, document pages are arranged in the order of pages across each page of the spread pages. As described above, the arrangement order is automatically applied such that a mismatch in the page order does not occur in the front cover and the rear cover, and thus, the integrity of the page order is maintained in the entire bookbinding printing.

When the setting “use spread layout during bookbinding” is made in the setting area 302 shown in FIG. 3A, four pages are arranged on one surface of a paper sheet (a physical page) if the setting “four pages/sheet” in the page layout setting area 301 and bookbinding printing are used in combination. In other words, eight pages are arranged on both sides of a paper sheet. In FIGS. 6A to 9E, a description has been given taking an example in which the number of pages of original data is sixteen which is a multiple of four for ease of explanation. Next, a description will be given of an adjustment process for inserting data for blank pages into original data when the number of pages of original data to be arranged on the physical sheets during bookbinding is not an integer multiple of the number of pages which are arrangeable on the physical sheets during bookbinding printing.

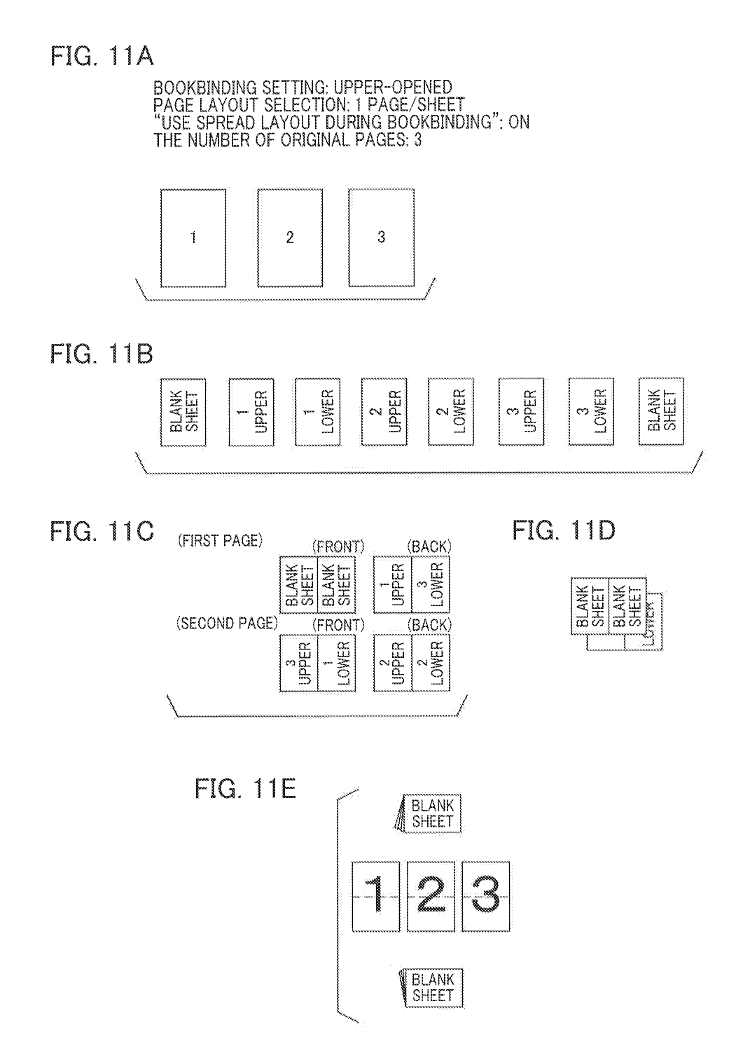

FIGS. 10A and 10B are explanatory diagrams illustrating an example of processing for adjusting the number of pages of print data (referred to as “N” and, in the present embodiment, N=8), which is arrangeable on the physical sheets during bookbinding printing, by adding blank sheets so as to be an integer multiple of “N”. In the present embodiment, a description will be given of an insertion process for inserting four pages of blank sheet data into original data when the page layout setting “four pages/sheet”, the bookbinding printing, and the setting “use spread layout during bookbinding” are specified and the number of pages of original data is 12.

Firstly, when the page layout setting “four pages/sheet” and the bookbinding printing are used in combination, eight pages are arranged on a physical sheet. When the number of pages of print data is 12, two physical sheets are required but sixteen pages of print data can be arranged on two physical sheets. Thus, an insertion process for inserting the difference four pages (see thirteenth to sixteenth pages) of blank sheet data into original data is performed as shown in FIG. 10A. The same process as described above is performed for sixteen pages in total of print data by the addition of four pages of blank sheet data. As in FIG. 9B, FIG. 103 shows a layout process for assigning each four pages out of sixteen pages of print data to each two pages for the book.-bound sheet bundle.

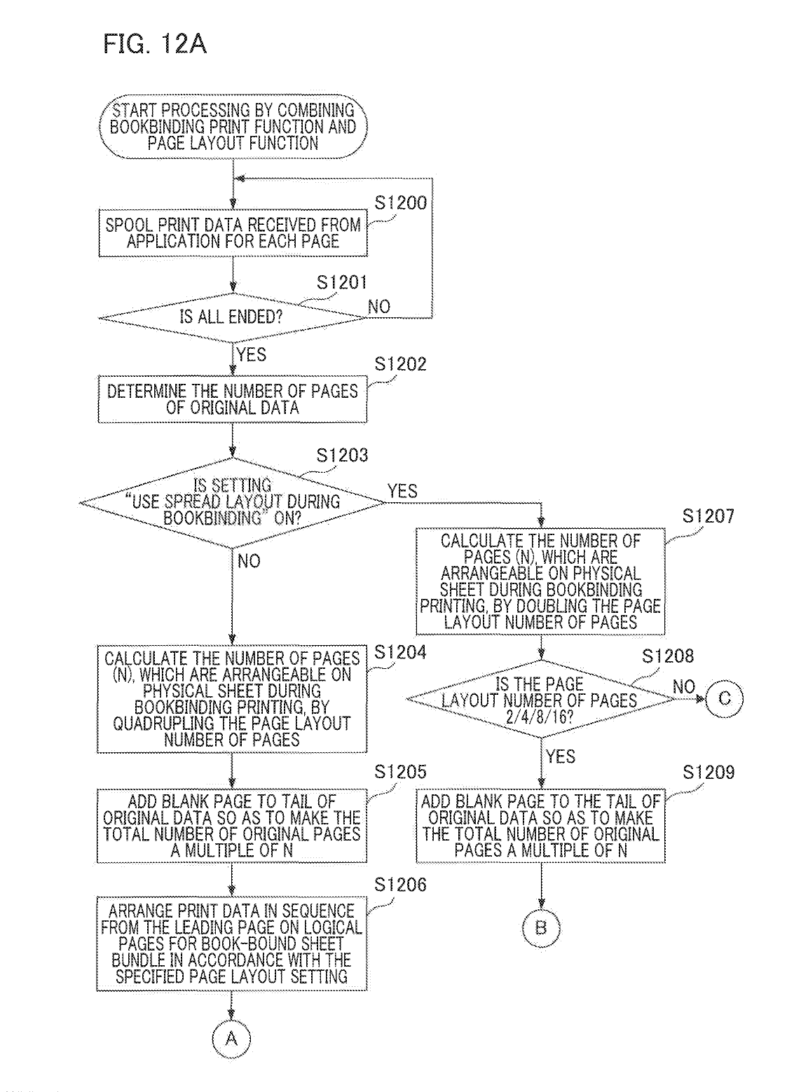

Next, a description will be given of a process performed when the setting “one page/sheet” and the setting “use Spread layout during bookbinding” are made with reference to FIGS. 11A to 11E. In the present embodiment, assume that the setting “upper-opened” is made as the opening direction, the page layout setting “one page/sheet” (see FIG. 3B) is specified, and the setting “use spread layout during bookbinding” shown in FIG. 3A is specified. FIG. 11A shows the original pages (three pages in total). Since one page is arranged across two pages of the spread pages for the book-bound sheet bundle, the logical pages for the front cover and the rear cover which are not spread pages for a book-bound sheet bundle are set to be blank sheets as shown in FIG. 11B. Original data including pages 1 to 3 is divided in half and the divided original data is arranged on each page of the spread pages for a book-bound sheet bundle. The symbols “upper” and “lower” added to each page number represent areas of the upper half and the lower half of each page obtained by the division of each original page, respectively. In the settings shown in FIGS. 11A to 11E, four pages (two pages of original pages) are arranged on a physical sheet during bookbinding printing, a process for inserting blank pages to the tail of original data is performed such that the total number of logical pages is a multiple of four. In the example shown in FIGs. 11A to 11E, the total number of original pages is eight: two pages of blank sheets used as the front cover and the rear cover and six pages which are the divided original data of three pages. Thus, no further insertion of blank pages is required in the present embodiment. As shown in FIGS. 11C to 11E, the generated pages are rearranged for bookbinding printing. For example, original data with the size of A3 can be formed into a book-bound article with the size of A4. When the size of original data does not fit into the size of the spread pages for the book-bound sheet bundle, an adjustment process for enlarging or reducing the size of each document page prior to division so as to fit into the size of the spread pages for the book-bound sheet bundle or a process for only reducing the size of only image data that is too large to fit into the size of the spread pages.

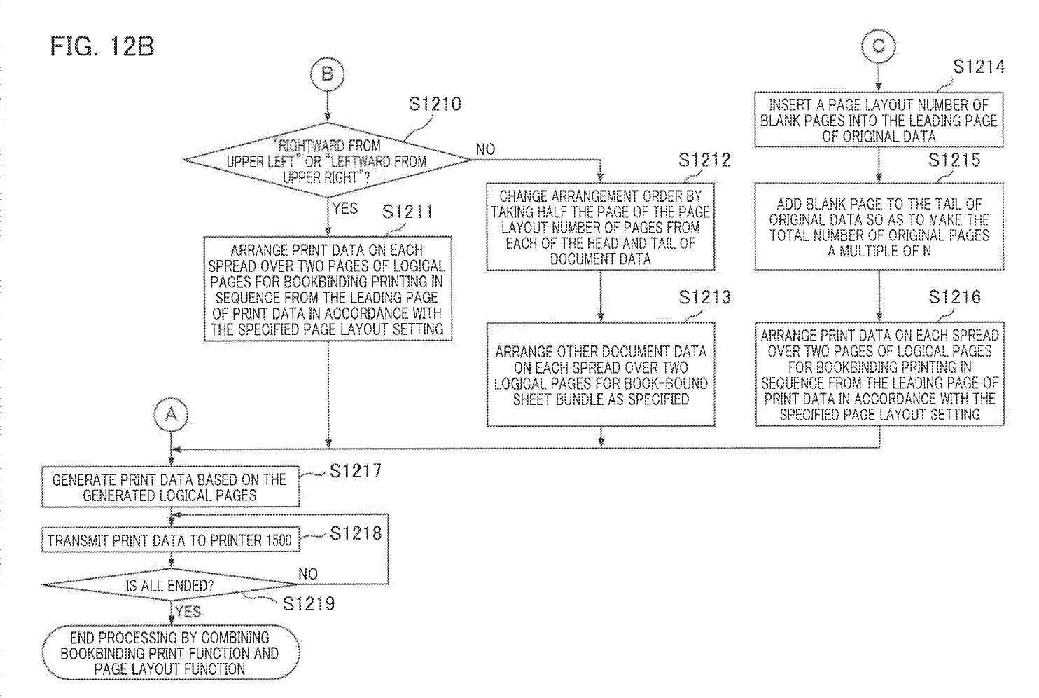

Next, a description will be given of an exemplary process performed when the bookbinding print function and the page layout function are used in combination with reference to the flowchart shown in FIGS. 12A and 12B. The following process is realized by reading a program relating to the flowchart of the present invention from a memory by the CPU 1 and executing the program by the same.

A print process is executed in a state in which the bookbinding print function and the page layout function are respectively set in the UI screens 300 and 400 of the printer driver 203 shown in FIGS. 3A to 46, respectively. The setting process is performed under the control of the CPU 2 shown in FIG. 1 when setting information, which is set by a user by operating the keyboard 9, a pointing device (not shown), or the like on the screen displayed by the display 10, is processed by the keyboard controller 5. In step S1200, original data received from the application 201 is temporarily spooled by the printer driver 203 for each page. When it is determined in step S1201 that spooling has been ended, the number of pages of original data is determined (step S1202). When it is determined in step S1201 that spooling has not been ended, the process returns to step S1200.

After step S1202, the printer driver 203 determines whether or not the setting “use spread layout during bookbinding” has been made in the setting area 302 shown in FIG. 3A (step S1203). When, the setting has not been made, the process in steps S1204 to S1206 is executed, and thus, the process exemplified in FIGS. 6A to 6E is performed. In other words, the number of pages set in the page layout setting area 301 is quadrupled to thereby calculate the number of pages which are arrangeable on a physical sheet during bookbinding printing (step S1204). For example, when the setting “two pages/sheet” is made, the number of pages calculated in step S1204 is eight. Next, as described with reference to FIGS. 10A and 10B, a process for adding a blank page(s) to the original pages of original data spooled by the printer driver 203 is executed. In this manner, the total number of pages becomes an integer multiple of the number of pages which are arrangeable on a physical sheet during bookbinding printing (step S1205). Next, a process for arranging the spooled original data on each of pages for a book-bound sheet bundle in sequence from the leading page in accordance with the specified page layout setting and arrangement order is executed to thereby generate the logical pages for bookbinding printing (step S1206). Then, the process advances to step S1217.

When the setting “use spread layout during bookbinding” has been made in step S1203, the process advances to step S1207. The number of pages set in the page layout setting is doubled to thereby calculate the number of pages which are arrangeable on a physical sheet during bookbinding printing. For example, when the setting “four pages/sheet” is made, the number of pages calculated is eight. Then, the set number of layout pages is determined (step S1208). When the number of layout pages is 2, 4, 8, or 16, the process advances to step S1209, whereas when the number of layout pages is other than 2, 4, 8, or 16, the process advances to step S1214.

As described with reference to FIGS. 10A and 10B, a process for adding a blank page (a) to original data spooled by the printer driver 203 is executed in step S1209. In this mariner, the total number of pages becomes an integer multiple of the number of pages which are arrangeable on a physical sheet during bookbinding printing. Next, the printer driver 203 determines the arrangement order (see 303) shown in FIG. 3C (step S1210). In other words, the printer driver 203 determines that the setting “rightward from upper left” or “leftward from upper right” is selected or the setting “downward from upper left” or “downward from upper right” is selected as the arrangement order. Consequently, when the setting “rightward from upper left” or “leftward from upper right” is selected, the process advances to step S1211, and the process exemplified in FIGS. 7A to 7E is performed. When the setting “downward from upper left” or “downward from upper right” is selected, the process advances to step S1212, and the process exemplified in FIGS. 9A to 9E is performed.

A description will be given of the process exemplified in FIGS. 7A to 7E. A process for allocating the spooled original data into each of pages for a book-bound sheet bundle in sequence from the leading page in accordance with the specified arrangement order is performed to thereby generate the logical pages for bookbinding printing (step S1211). More specifically, the page numbers are allotted in continuous order on each page of the spread pages of a book during bookbinding printing and a page subsequent to the last page on one page of the spread pages is arranged on the next page of the spread pages. With this arrangement, a process for allocating document pages across each page of the spread pages in continuous order is performed. Then, the process advances to step S1217. On the other hand, in the case of the process exemplified in FIGS. 9A to 9E, a process for taking half the pages of the number of layout pages from each of the head and tail of the spooled original data is performed. In the present embodiment, the setting “four pages/sheet” is made, two pages (half of four pages/sheet) are the leading pages (1, 2) and the tail end pages (15, 16). At this time, when the setting “downward from upper left” is made, the arrangement order is changed to “rightward from upper left”, whereas when the setting “downward from upper right” is made, the arrangement order, is changed to “leftward from upper right”, and thus, the logical pages for bookbinding printing is generated in accordance with the arrangement order (step S1212). More specifically, a process for allocating document pages is performed such that the page numbers are allotted in discontinuous order on each page of the spread pages of a book during bookbinding printing (e.g., 2 and 4) and the page numbers are allotted in continuous order across the spread pages (e.g., 3 and 4). Then, for other original data, a process for allocating the specified number of layout pages into each page of the spread pages for a book-bound sheet bundle is performed in accordance with the specified arrangement order to thereby generate the logical pages for bookbinding printing (step S1213). In the example, when it is determined that a mismatch occurs in the page order of the front cover and the rear, cover, the arrangement order is automatically changed. However, a blank logical page may also be inserted as the front cover. A blank logical page insertion process may also be performed under the condition of not increasing the number of physical sheets required for bookbinding printing so as to save paper sheets.

When the number of layout pages is six or nine, a process for inserting a page layout number of blank pages into the leading page of original data is executed in step S1208 (step S1214). Next, a blank page is added to the tail of original data as described with reference to FIGs. 10A and 10E. In this manner, the total number of pages becomes an integer multiple of the number of pages which are arrangeable on a physical sheet of a book-bound sheet bundle (step S1215). Then, for original data to which blank page data has been added, a process for allocating the specified number of layout pages into two pages of the spread pages for a book-bound sheet bundle is performed in accordance with the specified arrangement order to thereby generate the logical pages for bookbinding printing (step S1216). Then, the process advances to step S1217.

When all the logical pages for a book-bound sheet bundle are completed by the aforementioned processes, print data is generated based on all the generated logical pages in step S1217, the host computer 3000 then transmits print data to the printer 1500 (step S1218), and a print operation is performed by the printer 1500. When it is determined in step S1219 that all printing has been completed, a series of the aforementioned processes is ended. When it is determined in step S1219 that all printing has not been completed, the process returns to step S1238. When the printer 1500 has a folding function, the physical sheets are folded by the folding function unit provided in the printer 1500 to thereby obtain a book-bound sheet bundle. When the printer 1500 does not have a folding function, the output printed physical sheets are manually folded by a user to thereby generate a book-bound sheet bundle.

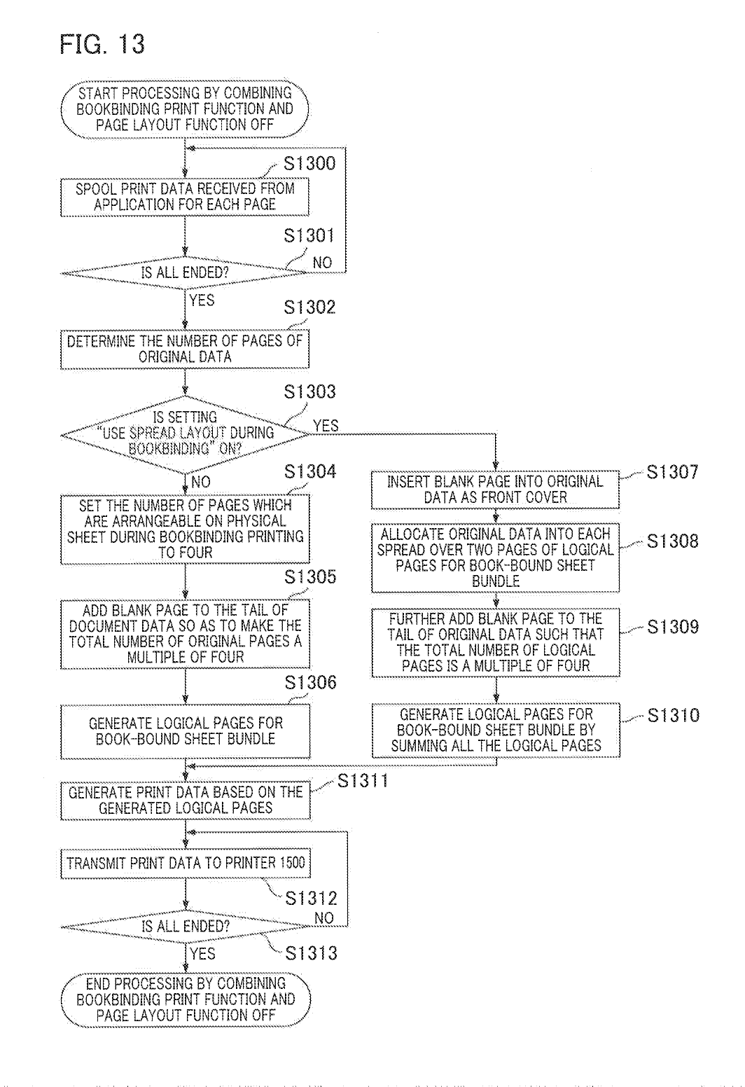

Next, a description will be given of a process performed when the page layout function is unset and the bookbinding print function is set under the setting of “one page/sheet” with reference to FIGS. 11A to 11E and the flowchart shown in FIG. 13. The processes in steps S1300 to S1303 are the same as those in steps S1200 to S1203 shown in FIG. 12A, and the processes in steps S1311 to S1313 are the same as those in steps S1217 to S1219 shown in FIG. 12B. Thus, the following description will be given only of the processes in steps S1304 to S1310.

When the setting “use spread layout during bookbinding” is not made in step S1303, the number of pages which are arrangeable on a physical sheet during bookbinding printing is four (step S1304). Next, as shown in FIGS. 10A and 10B, a process for adding a blank page(s) to the number of pages of the spooled original data is executed, and thus, the total number of pages is an integer multiple of four (step S1303). A process for the allocating original data to which a blank sheet(s) has been added into each page is executed such that original data is allocated in page multiples while turning over pages of a book-bound sheet bundle to thereby generate the logical pages for bookbinding printing (step S1306). Then, the process advances to step S1311.

On the other hand, when the setting “use spread layout during bookbinding” is made in step S1303, a blank page(s) is inserted into original data as the front cover of a book-bound sheet bundle (step S1307), and a process for allocating original pages of original data into two pages of the spread pages for a book-bound sheet bundle is executed (step S1308). A blank page is added to the tail of original data such that the total number of logical pages is an integer multiple of four (step S1309). As shown in FIGS. 11A to 11E, the eight logical pages in total for bookbinding printing are generated by the combination of a blank logical page for front cover, six logical pages into which half of each page of original data is allocated, and a blank logical page added to the tail thereof (step S1310). Then, the process advances to step S1311.

As described above, the page layout of the book-bound sheet bundle can be created in the spread-out manner when the bookbinding print function and the page layout function are used in combination in the book-bound sheet bundle so that a user can select the layout freely depending on print data. While, in the present embodiment, the host computer 3000 generates print data by rear rearranging pages for bookbinding printing, a printing device may perform the rearrangement of pages. In this case, the host computer 3000 generates print data without rearranging the page order of original data, but the host computer 3000 describes a page rearrangement method in print data.

Aspects of the present invention can also be realized by a computer of a system or apparatus (or devices such as a CPU or MPU) that reads out and executes a program recorded on a memory device to perform the functions of the above-described embodiments, and by a method, the steps of which are performed by a computer of a system or apparatus by, for example, reading out and executing a program recorded on a memory device to perform the functions of the above-described embodiments. For this purpose, the program is provided to the computer for example via a network or from a recording medium of various types serving 33 the memory device (e.g., computer-readable medium).

While the present invention has been described with reference to exemplary embodiments, it is to be understood that the invention is not limited to the disclosed exemplary embodiments. The scope of the following claims is to foe accorded the broadest interpretation so as to encompass all such modifications and equivalent structures and functions.

This application claims the benefit of Japanese Patent Applications No. 2011-095128 filed on Apr. 21, 2011 and 2012-034976 filed on Feb. 21, 2012, which are hereby incorporated by reference herein in their entirety.

What is claimed is:

1. A print processing apparatus comprising:
a setting unit configured to set a first layout process for arranging a page of original data on each of a first printing area and a second printing area both constituting spread pages of a book or set a second layout process for arranging a page of original data across the spread pages of the book; and
a print control unit configured to generate print data in which a plurality of pages is continuously arranged on the first printing area constituting the spread pages of the book and a plurality of pages subsequent to the plurality of pages arranged on the first printing area is continuously arranged on the second printing area when the first layout process is set by the setting unit or generate print data in which a plurality of pages is continuously arranged across the first printing area and the second printing area when the second layout process is set by the setting unit,
wherein a printed matter obtained when the first layout process is set and a printed matter obtained when the second layout process is set have a different layout of the original data in the spread pages of the book.

2. The print processing apparatus according to claim 1, wherein, when the second layout process is set by the setting unit, the print control unit determines whether or not a mismatch is generated in the page order if the plurality of pages is arranged on the spread pages for the book-bound sheet bundle in accordance with the specified arrangement order during a page layout process, and, when the print control unit determines that the mismatch occurs, the print control unit changes the arrangement order of pages which are a front cover and a rear cover of the book-bound sheet bundle and arranges pages excluding pages which are the front cover and the rear cover on the spread pages for the book-bound sheet bundle in accordance with the specified arrangement order so as to maintain the integrity of the page order.

3. The print processing apparatus according to claim 1, wherein the print control unit determines whether or not the number of pages of the original data is an integer multiple of the number of pages which are arrangeable on output sheets used in bookbinding printing, and, when the print control unit determines that the number of pages of the original data is not an integer multiple of the number of pages which are arrangeable on the output sheets used in the bookbinding printing, the print control unit adds a blank page(s) to thereby adjust the number of pages of the original data so as to be an integer multiple of the number of pages which are arrangeable on the output sheets used in the bookbinding printing.

4. The print processing apparatus according to claim 3, wherein the print control unit arranges the blank pages on the front cover and the rear cover of the book-bound sheet, bundle and arranges pages excluding page a which are the front cover and the rear cover on the spread pages for the book-bound sheet bundle in accordance with the specified arrangement order based on the condition that the number of output sheets used in the bookbinding printing is not increased.

5. The print processing apparatus according to claim 3, wherein the print control unit divides pages excluding pages which are the front cover and the rear cover of the book-bound sheet bundle, and arranges the divided pages on each page of the spread pages of the book.

6. The print processing apparatus according to claim 5, wherein the print control unit adjusts the size of the pages by enlargement or reduction in size thereof in conformity with the size of two pages of the spread pages of the book prior to division of the pages.

7. A print, processing method to be executed by a print processing apparatus that generates print data according to a printed matter having a different layout of original data in spread pages of a book, the method comprising:
setting, in a setting step, a first layout process for arranging a page of original data on each of a first printing area and a second printing area both constituting spread pages of the book or setting a second layout process for arranging a page of original data across the spread pages of the book; and
generating, in a print control step, print data in which a plurality of pages is continuously arranged on the first printing area constituting the spread pages of the book and a plurality of pages subsequent to the plurality of pages arranged on the first printing area is continuously arranged on the second printing area when the first layout process is set by the setting step or generating print data in which a plurality of pages is continuously arranged across the first printing area and the second printing area when the second layout process is set by the setting step.

8. The print processing method according to claim 7, wherein, determining, in a determination step, whether or not a mismatch is generated in the page order if the plurality of pages is arranged on the spread pages for the book-bound sheet bundle in accordance with the specified arrangement order during a page layout process when the second layout process is set by the setting step; and
changing the arrangement order of pages which are a front cover and a rear cover of the book-bound sheet bundle and arranging pages excluding pages which are the front cover and the rear cover on the spread pages for the book-bound sheet bundle in accordance with the specified arrangement order so as to maintain the integrity of the page order when it is determined in the determination step that the mismatch occurs.

9. The print processing method according to claim 7, wherein, determining, in a determination step, whether or not the number of pages of the original data is an integer multiple of the number of pages which are arrangeable on output sheets used in bookbinding printing; and
adding a blank page(s) to thereby adjust the number of pages of the original data so as to be an integer multiple of the number of pages which are arrangeable on the output sheets used in the bookbinding printing when it is determined in the determination step that the number of pages of the original data is not an integer multiple of the number of pages which are arrangeable on the output sheets used in the bookbinding printing.

10. The print processing method according to claim 9, wherein, arranging the blank pages on the front cover and the rear cover of the book-bound sheet bundle and arrange pages excluding pages which are the front, cover and the rear cover on the spread pages for the book-bound sheet bundle in accordance with the specified arrangement order based on the condition that the number of output sheets used in the bookbinding printing is not increased.

11. The print processing method according to claim 9, causing the computer to execute:
dividing pages excluding pages which are the front cover and the rear cover of the book-bound sheet bundle, and arranging the divided pages on each page of the spread pages of the book.

12. The print processing method according to claim 11, wherein, adjusting the size of the pages by enlargement or reduction in size thereof in conformity with the size of two pages of the spread pages of the book prior to division of the pages.

13. A print control program to be executed by a computer of a print processing apparatus that generates print data according to a printed matter having a different layout of original data in spread pages of a book, the print control program causing the computer to execute:
setting, in a setting step, a first layout process for arranging a page of original data on each of a first printing area and a second printing area both constituting spread pages of the book or setting a second layout process for arranging a page of original data across the spread pages of the book; and
generating, in a print control step, print data in which a plurality of pages is continuously arranged on the first printing area constituting the spread pages of the book and a plurality of pages subsequent to the plurality of pages arranged on the first printing area is continuously arranged on the second printing area when the first layout process is set by the setting step or generating print data in which a plurality of pages is continuously arranged across the first printing area and the second printing area when the second layout process is set by the setting step.

14. The print control program according to claim 13, causing the computer to execute:
determining, in a determination step, whether or not a mismatch is generated in the page order if the plurality of pages is arranged on the spread pages for the book-bound sheet bundle in accordance with the specified arrangement order during a page layout process when the second layout process is set by the setting step; and
changing the arrangement order of pages which are a front cover and a rear cover of the book-bound sheet bundle and arranging pages excluding pages which are the front cover and the rear cover on the spread pages for the book-bound sheet bundle in accordance with the specified arrangement order so as to maintain the integrity of the page order when it is determined in the determination step that the mismatch occurs.

15. The print control program according to claim 13, causing the computer to execute:
determining, in a determination step, whether or not the number of pages of the original data is an integer multiple of the number of pages which are arrangeable on output sheets used in bookbinding printing; and
adding a blank page(s) to thereby adjust the number of pages of the original data so as to be an integer multiple of the number of pages which are arrangeable on the output sheets used in the bookbinding printing when it is determined in the determination step that the number of pages of the original data is not an integer multiple of the number of pages which ere arrangeable on the output sheets used in the bookbinding printing.

16. The print control program according to claim 15, causing the computer to execute:
arranging the blank pages on the front cover and the rear cover of the book-bound sheet bundle and arranges pages excluding pages which are the front cover and the rear cover on the spread pages for the book-bound sheet bundle in accordance with the specified arrangement order based on the condition that the number of output sheets used in the bookbinding printing is not increased.

17. The print control program according to claim 15, causing the computer to execute:
dividing pages excluding pages which are the front cover and the rear cover of the book-bound sheet bundle, and arranging the divided pages on each page of the spread pages of the book.

18. The print control program according to claim 17, causing the computer to execute:
adjusting the size of the pages by enlargement or reduction in size thereof in conformity with the size of two pages of the spread pages of the book prior to division of the pages.
